(19) United States
(12) Patent Application Publication
(10) Pub. No.: US 2014/0160094 A1
(43) Pub. Date: Jun. 12, 2014

(54) READOUT UNIT AND ORGANIC LIGHT EMITTING DISPLAY APPARATUS HAVING THE SAME

(71) Applicant: Samsung Display Co., Ltd., Yongin-City (KR)

(72) Inventor: Hyeon-Ja JO, Yongin-City (KR)

(73) Assignee: Samsung Display Co., Ltd., Yongin-City (KR)

(21) Appl. No.: 13/904,141

(22) Filed: May 29, 2013

(30) Foreign Application Priority Data
Dec. 12, 2012 (KR) 10-2012-0144095

(51) Int. Cl. G09G 3/20

(52) U.S. Cl. CPC G09G 3/20
USPC 345/204

(57) ABSTRACT

A readout unit having an operation part configured to readout from a pixel circuit of a display panel to receive an input voltage indicating a pixel voltage based on a driving current driving an organic light emitting diode, to receive a reference voltage from a reference voltage terminal, and to compare the input voltage with the reference voltage to output an output voltage indicating a difference between the input voltage and the reference voltage, and an analog-digital converting part configured to convert a converter input voltage using the converter input voltage and an amplified voltage, the converter input voltage being based on the output voltage, the amplified voltage being amplified from the converter input voltage. Thus, change of a pixel may be accurately sensed irrelevantly to a capacitor of a display panel.

This application makes reference to, incorporates the same herein, and claims all benefits accruing under 35 U.S.C. §119 from an application earlier filed in the Korean Intellectual Property Office on 12 Dec. 2012 and there duly assigned Serial No 10-2012-0144095.

### BACKGROUND OF THE INVENTION

1. Field of the Invention

Example embodiments relate generally to a readout unit and an organic light emitting display apparatus having the readout unit.

2. Description of the Related Art

In an organic light emitting display panel including an organic light emitting diode, luminance and display quality of the organic light emitting display panel may be decreased due to deviation of process generated per a pixel circuit and deterioration of the organic light emitting display panel.

Thus, change of pixel in the organic light emitting display panel is sensed using a readout integrated circuit (ROIC).

However, an output of the ROIC changes when a capacitance of the organic light emitting display panel changes although a driving current driving the organic light emitting diode, and thus the change of the pixel may not be accurately sensed.

The above information disclosed in this Related Art section is only for enhancement of understanding of the background of the invention and therefore it may contain information that does not form the prior art that is already known to a person of ordinary skill in the art.

### SUMMARY OF THE INVENTION

Some example embodiments provide a readout unit capable of accurately sensing change of a pixel irrelevantly to a capacitor of a display panel.

Some example embodiments also provide an organic light emitting display apparatus having the above-mentioned readout unit.

According to some example embodiments, a readout unit may include an operation part configured to readout from a pixel circuit of a display panel to receive an input voltage indicating a pixel voltage based on a driving current driving an organic light emitting diode, to receive a reference voltage from a reference voltage terminal, and to compare the input voltage with the reference voltage to output an output voltage indicating a difference between the input voltage and the reference voltage, and an analog-digital converting part configured to convert a converter input voltage using the converter input voltage and an amplified voltage, the converter input voltage being based on the output voltage, the amplified voltage being amplified from the converter input voltage.

In example embodiments, the analog-digital converting part may include an amplifying part configured to amplify the converter input voltage to output the amplified voltage, and an analog-digital converter (ADC) configured to convert the converter input voltage to a digital shape using the converter input voltage and the amplified voltage.

In example embodiments, a least significant bit (LSB) of the ADC may change according to a capacitance of the display panel.

In example embodiments, the LSB of the ADC may increase as the capacitance of the display panel decreases.

In example embodiments, the analog-digital converting part may amplify the converting input voltage X (X is a natural number) times.

In example embodiments, the amplifying part may include an operational amplifier configured to receive the converter input voltage through a non-inverse input terminal, a first resistor connected between an inverse input terminal of the operational amplifier and a ground voltage terminal, and a second resistor connected between the inverse input terminal of the operational amplifier and an output terminal of the operational amplifier.

In example embodiments, the ADC may include a first input terminal receiving the converter input voltage, a second input terminal receiving the amplified voltage, and an output terminal outputting a digital output voltage converted to the digital shape from the converter input voltage.

In example embodiments, the operation part may include an operational amplifier configured to receive the input voltage through an inverse input terminal and receive the reference voltage through a non-inverse input terminal, a capacitor connected between the inverse input terminal of the operational amplifier and an output terminal of the operational amplifier.

In example embodiments, the readout unit may further include a low pass filter part configured to implement a low pass filter with respect to the output voltage.

In example embodiments, the readout unit may further include an inverting part configured to invert the output voltage.

According to some example embodiments, an organic light emitting display apparatus may include a display panel including a pixel circuit, a scan driving part configured to provide a scan signal to the pixel circuit, a data driving part configured to provide a data signal to the pixel circuit, a power supply part configured to provide a high power voltage and a low power voltage to the display panel, and a readout unit comprising an operation part configured to readout from the pixel circuit of the display panel to receive an input voltage indicating a pixel voltage based on a driving current driving an organic light emitting diode, to receive a reference voltage from a reference voltage terminal, and to compare the input voltage with the reference voltage to output an output voltage indicating a difference between the input voltage and the reference voltage, and an analog-digital converting part configured to convert a converter input voltage using the converter input voltage and an amplified voltage, the converter input voltage being based on the output voltage, the amplified voltage being amplified from the converter input voltage.

In example embodiments, the analog-digital converting part may include an amplifying part configured to amplify the converter input voltage to output the amplified voltage, and an analog-digital converter (ADC) configured to convert the converter input voltage to a digital shape using the converter input voltage and the amplified voltage.

In example embodiments, a least significant bit (LSB) of the ADC may change according to a capacitance of the display panel.

In example embodiments, the LSB of the ADC may increase as the capacitance of the display panel decreases.

In example embodiments, the analog-digital converting part may amplify the converting input voltage X (X is a natural number) times.

In example embodiments, the amplifying part may include an operational amplifier configured to receive the converter input voltage through a non-inverse input terminal, a first resistor connected between an inverse input terminal of the operational amplifier and a ground voltage terminal, and a second resistor connected between the inverse input terminal of the operational amplifier and an output terminal of the operational amplifier.

In example embodiments, the ADC may include a first input terminal receiving the converter input voltage, a second input terminal receiving the amplified voltage, and an output terminal outputting a digital output voltage converted to the digital shape from the converter input voltage.

In example embodiments, the operation part may include an operational amplifier configured to receive the input voltage through an inverse input terminal and receive the reference voltage through a non-inverse input terminal, a capacitor connected between the inverse input terminal of the operational amplifier and an output terminal of the operational amplifier.

In example embodiments, the organic light emitting display apparatus may further include a low pass filter part configured to implement a low pass filter with respect to the output voltage.

In example embodiments, the organic light emitting display apparatus may further include an inverting part configured to invert the output voltage.

Therefore, a readout unit and an organic light emitting display apparatus having the readout unit according to example embodiments may output the same digital output voltage with respect to the same driving current although a capacitance of a panel capacitor changes, and thus may accurately sense change of a pixel irrelevantly to a capacitor of a display panel.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a circuit diagram illustrating a readout unit according to an example embodiment of the present invention.

FIG. 2A is a graph illustrating a driving current applied to the readout unit of FIG. 1.

FIG. 2B is a graph illustrating an output voltage outputted from an operation part of FIG. 1.

FIG. 2C is a graph illustrating a least significant bit of an analog-digital converter in FIG. 1.

FIG. 2D is a graph illustrating a digital output voltage outputted from an analog-digital converting part of FIG. 1.

FIG. 3 is a circuit diagram illustrating a readout unit according to a comparison embodiment of the present invention.

FIG. 4A is a graph illustrating a driving current applied to the readout unit of FIG. 3.

FIG. 4B is a graph illustrating an output voltage outputted from an operation part of FIG. 3.

FIG. 4C is a graph illustrating a least significant bit of an analog-digital converting part in FIG. 3.

FIG. 4D is a graph illustrating a digital output voltage outputted from the analog-digital converting part of FIG. 3.

FIG. 5 is a block diagram illustrating an organic light emitting display apparatus according to another example embodiment of the present invention.

### DETAILED DESCRIPTION OF THE EMBODIMENTS

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

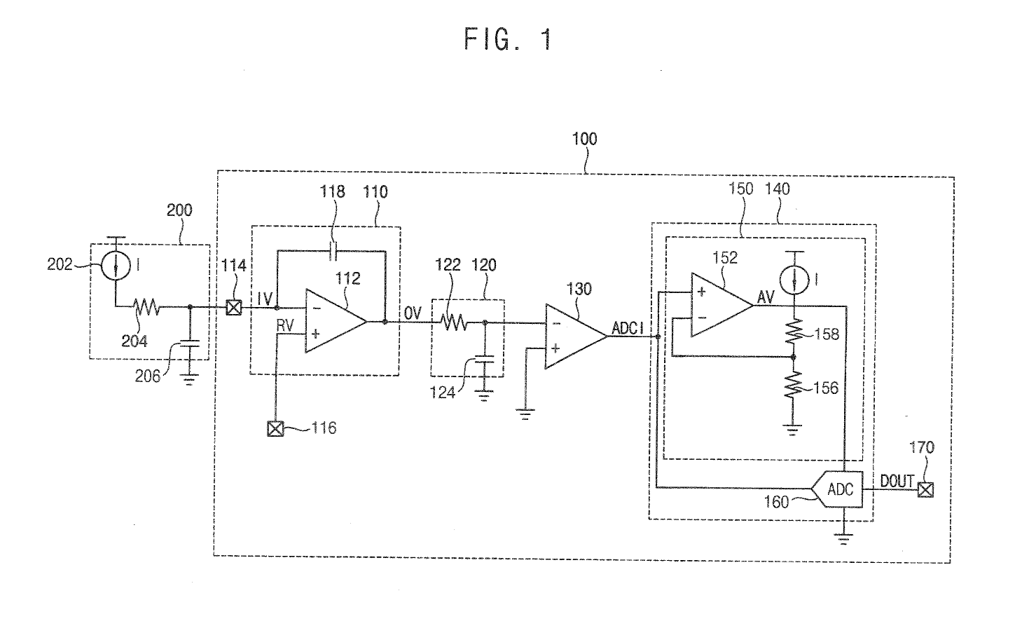

FIG. 1 is a circuit diagram illustrating a readout unit according to an example embodiment of the present invention.

Referring to FIG. 1, the readout unit 100 according to the present example embodiment includes an operation part 110, a low pass filter part 120, an inverting part 130 and an analog-digital converting part 140. The readout unit 100 readouts from a pixel circuit of a display panel 200 to sense a change of a pixel in the display panel 200.

The display panel 200 may be an organic light emitting display panel including an organic light emitting diode. The display panel 200 includes a current pat 202 outputting a driving current I driving the organic light emitting diode, a panel resistor 204 connected between the current part 202 and the readout unit 100, and a panel capacitor 206 connected between the panel resistor 204 and a ground voltage terminal.

The readout unit 100 receives the driving current I driving the organic light emitting diode, compares an input voltage IV indicating a pixel voltage based on the driving current I with a reference voltage RV to output an output voltage OV, and converts a converter input voltage ADCI based on the output voltage OV to a digital shape to output a digital output voltage DOUT. For example, the readout unit 100 may be a readout integrated circuit (ROIC).

The readout unit 100 outputs the same value when the driving current I is the same, although a capacitance of the panel capacitance 206 changes.

Specifically, the operation part 110 receives the input voltage IV from an input terminal 114 connected with the display panel 200, receives the reference voltage RV from a reference voltage terminal 116, and compares the input voltage IV with the reference voltage RV to output the output voltage OV. The output voltage OV may be a voltage difference between the input voltage IV and the reference voltage RV. The output voltage OV changes according to the capacitance of the panel capacitor 206 although values of the driving current I are the same.

The operation part 110 may include an operational amplifier 112 and a capacitor 118. The operational amplifier 112 receives the input voltage IV through an inverse input terminal, receives the reference voltage RV through a non-inverse input terminal and outputs the output voltage OV through an output terminal. The capacitor 118 may be connected between the inverse input terminal of the operational amplifier 112 and the output terminal of the operational amplifier 112. Thus, the operation part 110 may be an integrator.

The low pass filter part 120 implements a low pass filter with respect to the output voltage OV, and samples and holds the output voltage OV. The low pass filter part 120 may include a resistor 122 and a capacitor 124. The resistor 122 may be connected between the output terminal of the operational amplifier 112 in the operation part 110 and the inverting part 130, and the capacitor 124 may be connected between the resistor 122 and the ground voltage terminal.

The inverting part 130 inverts the output voltage OV to output the converter input voltage ADCI. The output voltage OV outputted from the operation part 110 may have a negative voltage, and thus the converter input voltage ADCI outputted from the inverting part 130 may have a positive voltage. In case that the output OV outputted from the operation part 110 is the positive voltage, the inverting part 130 may be omitted.

The analog-digital converting part 140 converts the converter input voltage ADCI to a digital shape to output the digital output voltage DOUT. The digital output voltage DOUT is not changed with respect to the same driving current I although the capacitance of the panel capacitor 206 changes.

The analog-digital converting part 140 outputs the digital output voltage DOUT using the converter input voltage ADCI and an amplified voltage AV generated by amplifying the converter input voltage ADCI. For example, the analog-digital converting part 140 may include an amplifying part 150 and an analog-digital converter (ADC) 160.

The amplifying part 150 amplifies the converter input voltage ADCI to output an amplified voltage AV to the ADC 160. For example, the amplifying part 150 may include an operational amplifier 152, a first resistor 156 and a second resistor 158.

The operational amplifier 152 receives the converter input voltage ADCI through a non-inverse input terminal, outputs the amplified voltage AV through an output terminal, and an inverse input terminal of the operational amplifier 152 may be connected between the first resistor 156 and the second resistor 158. The first resistor 156 may be connected between the inverse input terminal of the operational amplifier 152 and the ground voltage terminal. The second resistor 158 may be connected between the inverse input terminal of the operational amplifier 152 and the first resistor 156.

A relation of an input and an output of the amplifying part 150 is the same as [Equation 1]

Vo=Vi*((R2/R1)+1) [Equation 1]

Vo denotes the amplified voltage AV outputted from the operational amplifier 152, Vi denotes the converter input voltage ADCI inputted to the non-inverse input terminal of the operational amplifier 152, R1 denotes a resistance of the first resistor R1, and R2 denotes a resistance of the second resistor R2. Thus, the amplified voltage AV may be X (X is a natural number) times as the converter input voltage ADCI.

For example, when the resistance of the first resistor R1 and the resistance of the second resistor R2 are the same, the amplified voltage AV may be twice as the converter input voltage ADCI.

The ADC 160 output the digital output voltage DOUT to an output terminal 170 using the converter input voltage ADCI and the amplified voltage AV. A least significant bit (LSB) of the analog-digital converter 160 is changed according to the capacitance of the panel capacitor 206. Thus, the LSB of the ADC is changed according to the output voltage OV. The ADC 160 may include a first terminal receiving the converter input voltage ADCI, a second terminal receiving the amplified voltage AV, a third terminal connected to the ground voltage terminal, and an output terminal outputting the digital output voltage DOUT. For example, the ADC 160 may be 16 bits ADC.

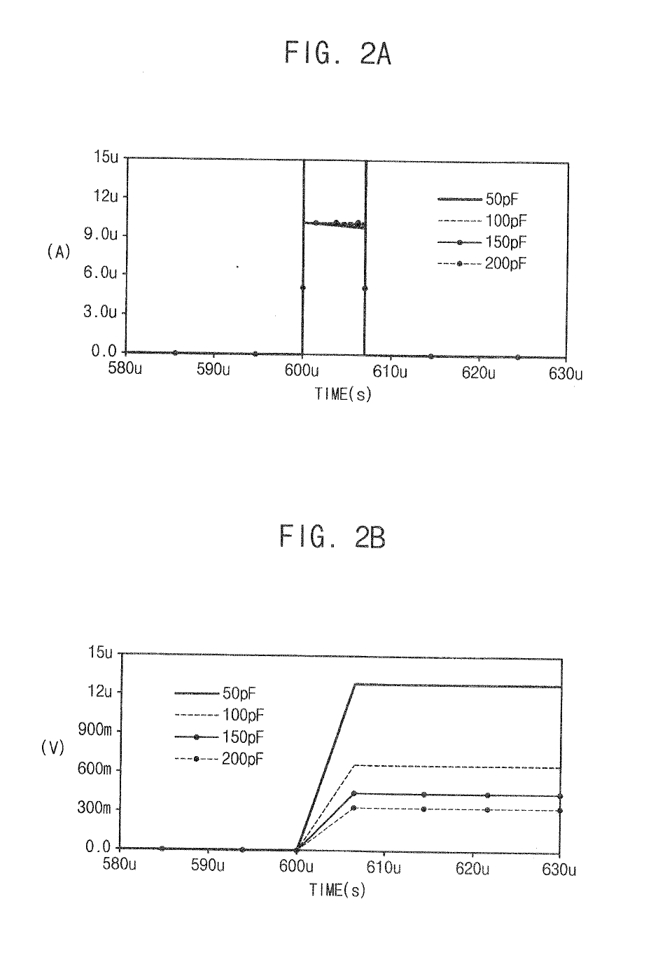

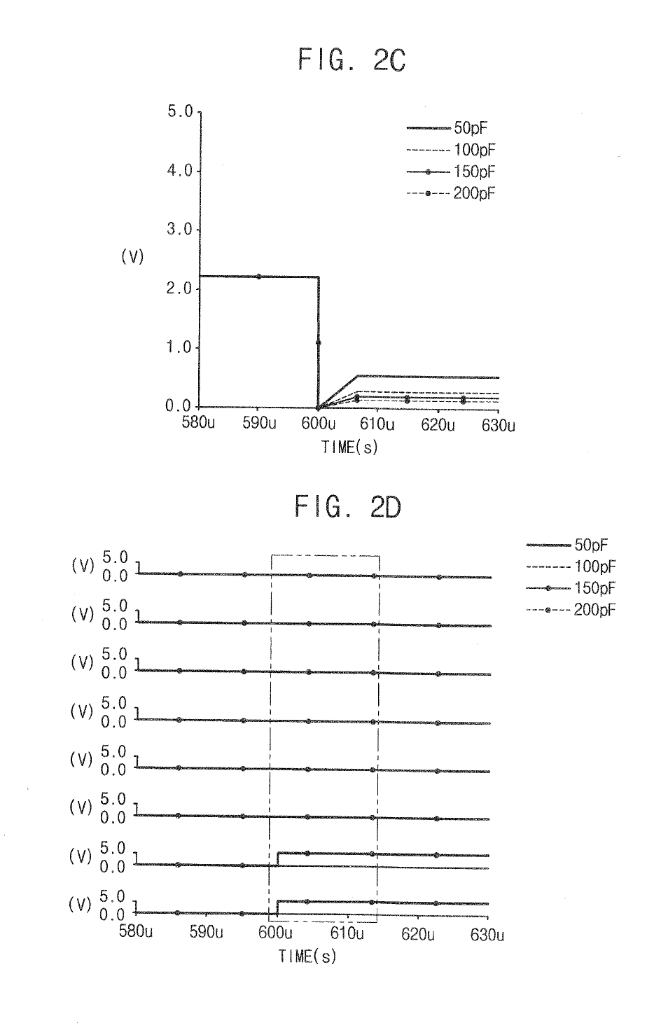

FIG. 2A is a graph illustrating the driving current I applied to the readout unit 100 of FIG. 1, FIG. 2B is a graph illustrating the output voltage OV outputted from the operation part 110 of FIG. 1, FIG. 2C is a graph illustrating the LSB of the ADC 160 in FIG. 1, and FIG. 2D is a graph illustrating the digital output voltage DOUT outputted from the analog-digital converting part 140 of FIG. 1.

Referring to FIGS. 1, 2A, 2B, 2C and 2D, the output voltage OV outputted from the operation part 110 changes according to the capacitance of the panel capacitor 206 although the driving current I is the same. Specifically, the output voltage OV increases as the capacitance of the panel capacitor 206 decreases with respect to the same driving current I, as illustrated in FIGS. 2A and 2B.

As illustrated in FIG. 2C, the LSB of the ADC 160 is changed according to the capacitance of the panel capacitor 206. Thus, the LSB of the ADC 160 is changed according to the output voltage OV. Specifically, the LSB of the ADC 160 increases as the capacitance of the panel capacitor 206 decreases.

As illustrated in FIG. 2D, the digital output voltage DOUT outputted from the analog-digital converting part 140 has the same output value although the capacitance of the panel capacitor 206 changes.

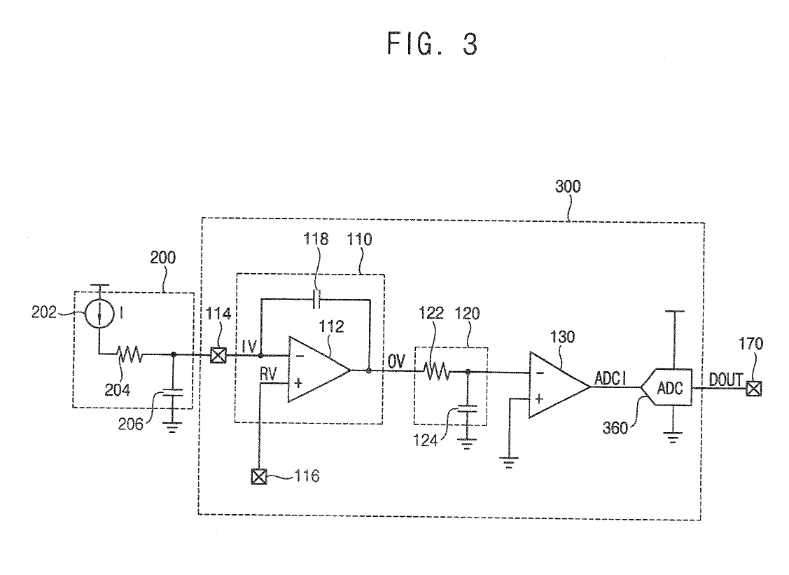

FIG. 3 is a circuit diagram illustrating a readout unit according to a comparison embodiment of the present invention.

Referring to FIG. 3, the readout unit 300 according to the present comparison embodiment includes an operation part 110, a low pass filter part 120, an inverting part 130 and an analog-digital converting part 360. The readout unit 300 readouts from a pixel circuit of a display panel 200 to sense a change of a pixel in the display panel 200.

The display panel 200 may be an organic light emitting display panel including an organic light emitting diode. The display panel 200 includes a current pat 202 outputting a driving current I driving the organic light emitting diode, a panel resistor 204 connected between the current part 202 and the readout unit 300, and a panel capacitor 206 connected between the panel resistor 204 and a ground voltage terminal.

The readout unit 300 receives the driving current I driving the organic light emitting diode, compares an input voltage IV indicating a pixel voltage based on the driving current I with a reference voltage RV to output an output voltage OV, and converts a converter input voltage ADCI based on the output voltage OV to a digital shape to output a digital output voltage DOUT. For example, the readout unit 300 may be a readout integrated circuit (ROIC).

The readout unit 300 outputs different same values when a capacitance of the panel capacitance 206 changes although the driving current I is the same.

Specifically, the operation part 110 receives the input voltage IV from an input terminal 114 connected with the display panel 200, receives the reference voltage RV from a reference voltage terminal 116, and compares the input voltage IV with the reference voltage RV to output the output voltage OV. The output voltage OV may be a voltage difference between the input voltage IV and the reference voltage RV. The output voltage OV changes according to the capacitance of the panel capacitor 206 although values of the driving current I are the same.

The operation part 110 may include an operational amplifier 112 and a capacitor 118. The operational amplifier 112 receives the input voltage IV through an inverse input terminal, receives the reference voltage RV through a non-inverse input terminal and outputs the output voltage OV through an output terminal. The capacitor 118 may be connected between the inverse input terminal of the operational amplifier 112 and the output terminal of the operational amplifier 112. Thus, the operation part 110 may be an integrator.

The low pass filter part 120 implements a low pass filter with respect to the output voltage OV, and samples and holds the output voltage OV. The low pass filter part 120 may include a resistor 122 and a capacitor 124. The resistor 122 may be connected between the output terminal of the operational amplifier 112 in the operation part 110 and the inverting part 130, and the capacitor 124 may be connected between the resistor 122 and the ground voltage terminal.

The inverting part 130 inverts the output voltage OV to output the converter input voltage ADCI. The output voltage OV outputted from the operation part 110 may have a negative voltage, and thus the converter input voltage ADCI outputted from the inverting part 130 may have a positive voltage. In case that the output OV outputted from the operation part 110 is the positive voltage, the inverting part 130 may be omitted.

The analog-digital converting part 140 converts the converter input voltage ADCI to a digital shape to output the digital output voltage DOUT. The digital output voltage DOUT is not changed with respect to the same driving current I although the capacitance of the panel capacitor 206 changes.

The analog-digital converting part 360 outputs the digital output voltage DOUT by converting the converter input voltage ADCI to the digital shape. A least significant bit (LSB) of the analog-digital converting part 360 is constant although the capacitance of the panel capacitor 206 changes, and the digital output voltage DOUT changes according to the capacitance of the panel capacitor 206 with respect to the same driving current I.

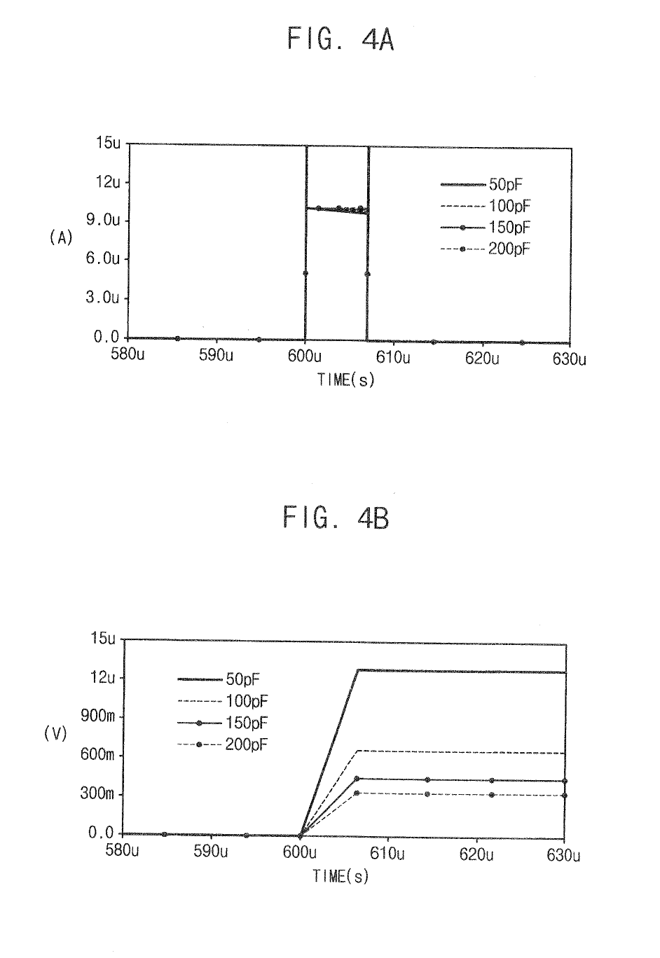

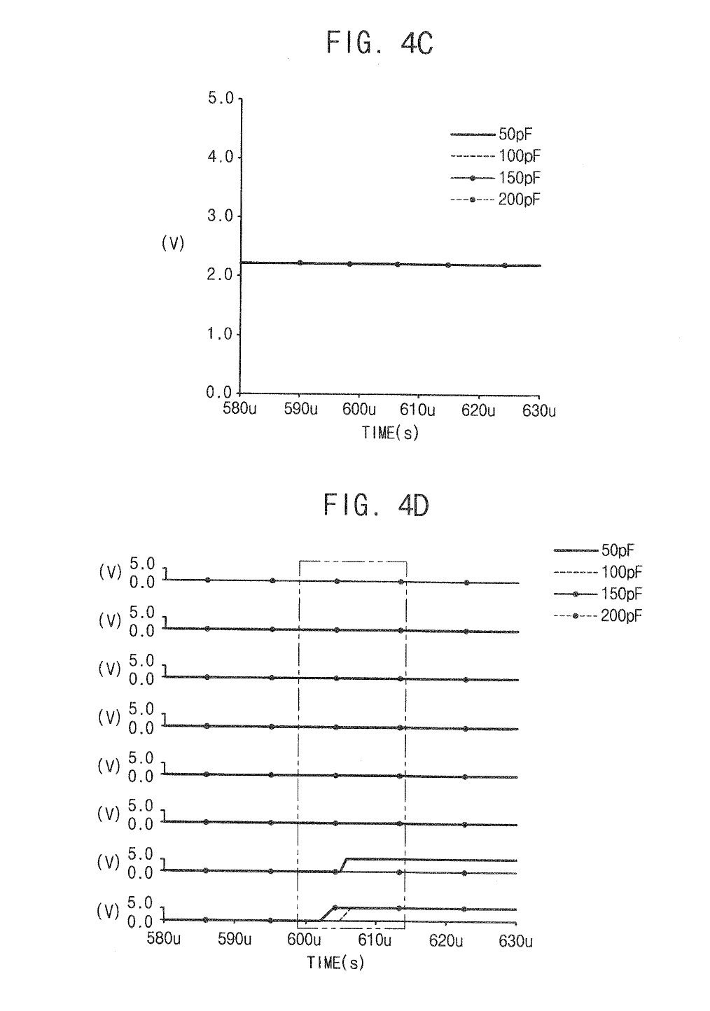

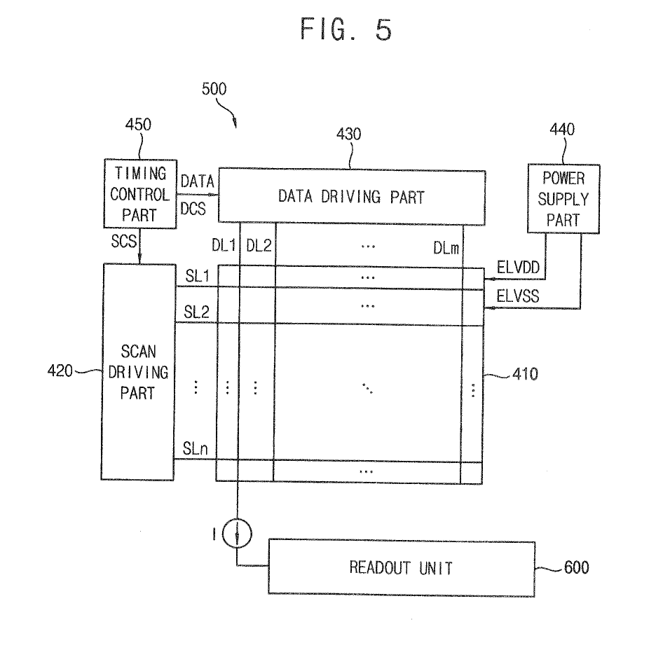

FIG. 4A is a graph illustrating the driving current I applied to the readout unit 300 of FIG. 3, FIG. 4B is a graph illustrating the output voltage OV outputted from the operation part 110 of FIG. 3, FIG. 4C is a graph illustrating the LSB of the analog-digital converting part 360 in FIG. 3, and FIG. 4D is a graph illustrating the digital output voltage DOUT outputted from the analog-digital converting part 360 of FIG. 3.

Referring to FIGS. 3, 4A, 4B, 4C and 4D, the output voltage OV outputted from the operation part 110 changes according to the capacitance of the panel capacitor 206 although the driving current I is the same. Specifically, the output voltage OV increases as the capacitance of the panel capacitor 206 decreases with respect to the same driving current I, as illustrated in FIGS. 4A and 4B.

As illustrated in FIG. 4C, the LSB of the analog-digital converting part 360 is constant although the capacitance of the panel capacitor 206 changes. Thus, the LSB of the analog-digital converting part 360 is constant although the output voltage OV changes. Specifically, the LSB of the ADC 160 increases as the capacitance of the panel capacitor 206 decreases.

As illustrated in FIG. 4D, the digital output voltage DOUT outputted from the analog-digital converting part 360 changes when the capacitance of the panel capacitor 206 changes.

FIG. 5 is a block diagram illustrating an organic light emitting display apparatus according to another example embodiment of the present invention.

Referring to FIG. 5, the organic light emitting display apparatus 500 according to the present example embodiment includes a display panel 410, a scan driving part 420, a data driving part 430, a power supply part 440, a timing control part 450 and a readout unit 600.

The display panel 410 includes a plurality of pixel circuits to display an image based on an image data DATA. Specifically, the display panel 410 includes a plurality of pixels formed area divided by scan lines SL1, SL2, . . . , SLn and data lines DL1, DL2, . . . , DLm. The display panel 410 displays the image based on scan signals provided from the scan driving part 420 and data signals provided from the data driving part 430. For example, each of pixels may include an organic light emitting diode, and thus the display panel 410 may be an organic light emitting display panel.

The scan driving part 420 provides the scan signals to the pixel circuits. Specifically, the scan driving part 420 generates the scan signals in response to a scan driving control signal SCS provided from the timing control part 450. The scan signals generated from the scan driving part 420 are sequentially provided to the scan lines SL1, SL2, . . . , SLn.

The data driving part 430 provides the data signals to the pixel circuits. Specifically, the data driving part 430 generates the data signals in response to a data driving control signal DCS provided from the timing control part 450. The data signals generated from the data driving part 430 are sequentially provided to the data lines DL1, DL2, . . . , DLm.

The power supply part 440 generates a high power voltage ELVDD and a low power voltage ELVSS and provides the high power voltage ELVDD and the low power voltage ELVSS to the pixel circuits through a plurality of power lines.

The timing control part 450 receives a control signal from an outside to generate the scan driving control signal SCS and the data driving control signal DCS, provides the scan driving control signal SCS to the scan driving part 420 and provides the data driving control signal DCS to the data driving part 430. In addition, the timing control part 450 provides the image data DATA to the data driving part 430.

The readout unit 600 senses a change of the pixels in the pixel circuits. Specifically, the readout unit 600 readouts from the pixel circuits of the display panel 410 to receive a driving current I driving the organic light emitting diode in the pixel circuits, compares an input voltage based on the driving current and a reference voltage to output an output voltage, and converts a voltage based on the output voltage to a digital shape to output a digital output voltage.

The readout unit 600 may be substantially the same as the readout unit 100 according to the previous example embodiment illustrated in FIG. 1. Thus, detailed explanation concerning the readout unit 600 is omitted.

According to the present example embodiments, the readout unit 100 and 600 amplifies the converter input voltage ADCI and changes the LSB of the ADC 160 according to the converter input voltage ADCI. Therefore, the digital output voltage DOUT with respect to the same driving current I may be the same although the capacitance of the panel capacitor 206 changes, and thus change of the pixel may be accurately sensed irrelevantly to a capacitance of the display panel 200 and 410.

The present inventive concept may be applied to an electric device having a display apparatus. For example, the present inventive concept may be applied to a television, a computer monitor, a laptop, a digital camera, a cellular phone, a smart phone, a personal digital assistant (PDA), a portable multimedia player (PMP), a navigation system, a video phone, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A readout unit, comprising:
an operation part configured to readout from a pixel circuit of a display panel to receive an input voltage indicating a pixel voltage based on a driving current driving an organic light emitting diode, to receive a reference voltage from a reference voltage terminal, and to compare the input voltage with the reference voltage to output an output voltage indicating a difference between the input voltage and the reference voltage; and
an analog-digital converting part configured to convert a converter input voltage using the converter input voltage and an amplified voltage, the converter input voltage being based on the output voltage, the amplified voltage being amplified from the converter input voltage.

2. The readout unit of claim 1, wherein the analog-digital converting part comprises:
an amplifying part configured to amplify the converter input voltage to output the amplified voltage; and
an analog-digital converter (ADC) configured to convert the converter input voltage to a digital shape using the converter input voltage and the amplified voltage.

3. The readout unit of claim 2, wherein a least significant bit (LSB) of the ADC changes according to a capacitance of the display panel.

4. The readout unit of claim 3, wherein the LSB of the ADC increases as the capacitance of the display panel decreases.

5. The readout unit of claim 2, wherein the analog-digital converting part amplifies the converting input voltage X (X is a natural number) times.

6. The readout unit of claim 2, wherein the amplifying part comprises:
an operational amplifier configured to receive the converter input voltage through a non-inverse input terminal;
a first resistor connected between an inverse input terminal of the operational amplifier and a ground voltage terminal; and
a second resistor connected between the inverse input terminal of the operational amplifier and an output terminal of the operational amplifier.

7. The readout unit of claim 2, wherein the ADC comprises:
a first input terminal receiving the converter input voltage;
a second input terminal receiving the amplified voltage; and
an output terminal outputting a digital output voltage converted to the digital shape from the converter input voltage.

8. The readout unit of claim 1, wherein the operation part comprises:
an operational amplifier configured to receive the input voltage through an inverse input terminal and receive the reference voltage through a non-inverse input terminal; and
a capacitor connected between the inverse input terminal of the operational amplifier and an output terminal of the operational amplifier.

9. The readout unit of claim 1, further comprising:
a low pass filter part configured to implement a low pass filter with respect to the output voltage.

10. The readout unit of claim 1, further comprising:
an inverting part configured to invert the output voltage.

11. An organic light emitting display apparatus, comprising:
a display panel including a pixel circuit;
a scan driving part configured to provide a scan signal to the pixel circuit;
a data driving part configured to provide a data signal to the pixel circuit;
a power supply part configured to provide a high power voltage and a low power voltage to the display panel; and
a readout unit comprising an operation part configured to readout from the pixel circuit of the display panel to receive an input voltage indicating a pixel voltage based on a driving current driving an organic light emitting diode, to receive a reference voltage from a reference voltage terminal, and to compare the input voltage with the reference voltage to output an output voltage indicating a difference between the input voltage and the reference voltage, and an analog-digital converting part configured to convert a converter input voltage using the converter input voltage and an amplified voltage, the converter input voltage being based on the output voltage, the amplified voltage being amplified from the converter input voltage.

12. The organic light emitting display apparatus of claim 11, wherein the analog-digital converting part comprises:
an amplifying part configured to amplify the converter input voltage to output the amplified voltage; and
an analog-digital converter (ADC) configured to convert the converter input voltage to a digital shape using the converter input voltage and the amplified voltage.

13. The organic light emitting display apparatus of claim 12, wherein a least significant bit (LSB) of the ADC changes according to a capacitance of the display panel.

14. The organic light emitting display apparatus of claim 13, wherein the LSB of the ADC increases as the capacitance of the display panel decreases.

15. The organic light emitting display apparatus of claim 12, wherein the analog-digital converting part amplifies the converting input voltage X (X is a natural number) times.

16. The organic light emitting display apparatus of claim 12, wherein the amplifying part comprises:
an operational amplifier configured to receive the converter input voltage through a non-inverse input terminal;
a first resistor connected between an inverse input terminal of the operational amplifier and a ground voltage terminal; and
a second resistor connected between the inverse input terminal of the operational amplifier and an output terminal of the operational amplifier.

17. The organic light emitting display apparatus of claim 12, wherein the ADC comprises:
a first input terminal receiving the converter input voltage;
a second input terminal receiving the amplified voltage; and
an output terminal outputting a digital output voltage converted to the digital shape from the converter input voltage.

18. The organic light emitting display apparatus of claim 11, wherein the operation part comprises:
an operational amplifier configured to receive the input voltage through an inverse input terminal and receive the reference voltage through a non-inverse input terminal; and
a capacitor connected between the inverse input terminal of the operational amplifier and an output terminal of the operational amplifier.

19. The organic light emitting display apparatus of claim 11, further comprising:
a low pass filter part configured to implement a low pass filter with respect to the output voltage.

20. The organic light emitting display apparatus of claim 11, further comprising:
an inverting part configured to invert the output voltage.
